(19) United States
(12) Patent Application Publication
(10) Pub. No.: US 2004/0262328 A1
(43) Pub. Date: Dec. 30, 2004

(54) Beverage flavoring dispenser

(76) Inventor: Pamela A. Nilsen, Ft. Myers, FL (US)

Correspondence Address: Pamela A. Nilsen, 14880-12 Summerlin Woods Dr., Ft. Myers, FL, 33919, US

(21) Appl. No.: 10/386,410

(22) Filed: Jun. 30, 2003

(51) Int. Cl. B67D 5/56

(52) U.S. Cl. 222/129

(57) ABSTRACT

Having traveled with my ten grandchildren for assorted outings I decided to contribute to the harmony of the outing by bringing bottled water for each of them. Each would have preferred a flavored drink or iced tea rather than water. That being an expensive proposition I invented a solution. “Water and More”

This is a tube, sized to fit through the opening of a water bottle and retain its shape. It can be used as a disposable or open to be refilled. Its purpose is to dispense whichever flavor it is filled with and upon arriving at your destination (or lunch time) the water has been transformed to a flavored drink.

### FIELD OF INVENTION

This invention relates to a beverage flavoring dispenser and, more particularly, to a tubular dispenser than is inserted through the threaded opening of a standard plastic water bottle for dispensing a wide assortment of beverage flavorings to the water within the bottle.

### BACKGROUND OF INVENTION

Bottled drinking water is commonly available in various conveniently portable sizes (e.g., 8 oz., 16 oz. and one liter plastic bottles). Many children and adults nonetheless prefer flavored beverages such as juice or ice tea. Unfortunately, such drinks usually tend to be significantly more expensive than unflavored, bottled water. A need presently exists for a product that will allow an individual to flavor a standard, relatively in-expensive bottle of water as desired to suit his or her particular taste. Although tea diffusers have long been known, these devices are designed to be used in a pot, mug or cup and unable to fit through the small threaded opening of a typical water bottle.

### SUMMARY OF THE INVENTION

It is therefore an object of this invention to provide a beverage flavoring dispenser that can be conveniently inserted through the threaded opening of a standard plastic water bottle for dispensing a wide assortment of beverage flavorings to the water according to the user's particular taste.

It is a further object of this inventor to provide a flavoring dispenser for a water bottle that enables the user to inexpensively make and transport a wide variety of flavored beverages in a standard water bottle.

This invention features a beverage flavoring dispenser for use and dispensing a dissolvable flavoring into drinking water contained in a standard water bottle, having a threaded opening with threadably removable cap. This dispenser includes a cylindrical body having a closed lower end and an interior chamber for accommodating the dissolvable flavoring. The body has a series of perforations formed therein in communication with the chamber. An upper closure is connected to the body. The body and the closure define and elongate, substantially tubular enclosure that has a diameter that is narrower than the opening of the standard water bottle such that the enclosure is introducible into the interior of the water bottle through the opening of the bottle. As a result, flavoring within the chamber dissolves and is dispensed into the water through the perforations to flavor the water.

In a preferred embodiment, the upper closure is removably connected to the body. The closure on the body may be threadably interengaged. Alternatively, the upper closure may be permanently and unitarily attached to the body. Typically, the cylindrical body has a diameter of not greater than 1 inch. A flexible filament may be attached to and extend from the closure. A tag may be attached to the distal end of the filament for carrying an indicator that designates the type of flavoring in the chamber.

### DETAILED DESCRIPTION OF PREFERRED EMBODIMENTS

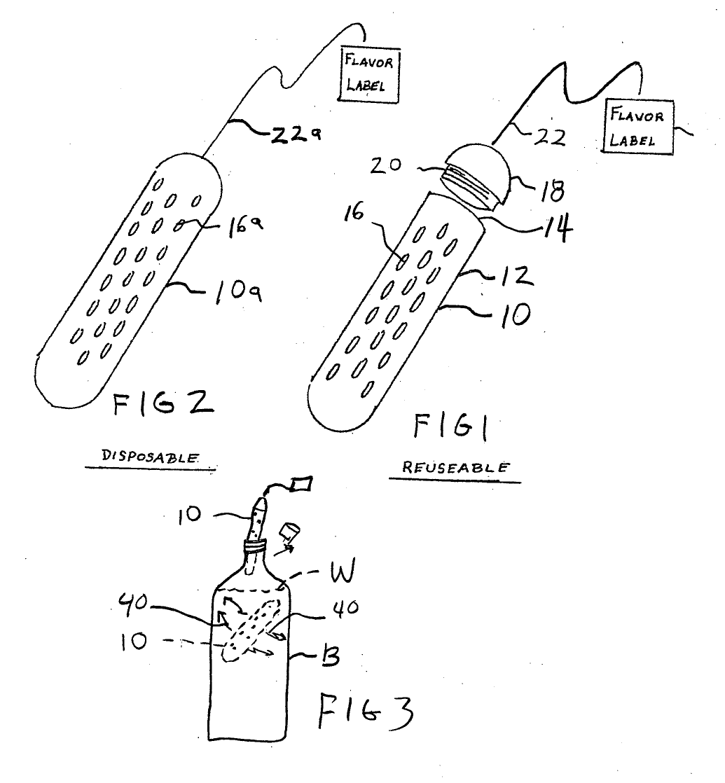

FIG. 1 is a perspective view of a reusable dispenser according to this invention;

FIG. 2 is a perspective view of a disposable dispenser according to this invention; and

FIG. 3 is an elevational view of the dispenser as inserted in a water bottle.

There is shown in FIG. 1 a reusable beverage flavoring dispenser 10, which includes an elongate cylindrical or tubular body 12 having an open upper end 14. A series of perforations 16 are formed through body 12 in communication with an interior chamber of the body. The number and placement of the perforations may vary.

A cap or closure 18 includes a cylindrical threaded portion 20 that is threadably engagable with complementary interior threads formed adjacent to upper end 14 of body 12. A filament, thread, string or similar element 22 attaches a flavor indicating label 24 to the closed upper end of cap 18. The cap is releasably engaged with body 12 by threadably interengaging the corresponding threads and screwing the cap onto the body.

In the alternative version shown in FIG. 2, dispenser 10a includes a body and an upper closure that are unitarily and permanently joined. In either embodiment, the body and closure of the dispenser are preferably composed of a molded plastic or similar material. As in the embodiment of FIG. 1, the dispenser 10a of FIG. 2 includes a plurality of holes or perforations 16a formed throughout the wall of the dispenser and communicating with the interior thereof. Once again, a flavor indicating label 24a is secured to the dispenser 10a by a string or filament 22a.

In operation, a selected beverage flavoring (e.g., juice, tea or various other flavorings in dissolvable powdered, granular, crystal or leaf form), is placed in the opening or interior chamber of tubular body 12. Cap. 18 is secured to the body. In the version of FIG. 2 the desired flavoring is placed in dispenser 10a by the manufacturer of the dispenser. In either case, the label 24, 24a designates the flavoring contained in the dispenser. In the reusable version the user marks the label as appropriate. The dispenser is then transported to the location at which it will be used.

To flavor his or her drink in the manner shown in FIG. 3, the user opens a standard-size plastic bottle of water B by removing the plastic cap. 30. Dispenser 10 (or a alternatively dispenser 10a) is then inserted into bottle B through standard threaded opening 32. As shown in phantom, the dispenser floats and/or is immersed in water W. The flavoring component dissolves and flavoring is dispensed into the water through the perforations 16 in the manner indicated by arrows 40. The water is thereby flavored as desired to suit the user's taste.

The dispenser of this invention is particularly intended and beneficial for use in flavoring a standard plastic bottle of drinking water. The thin, elongate shape of dispenser 10, 10a allows it to fit conveniently through the constricted opening of the bottle. Conventional diffusers are unable to do this. As a result, the typically inexpensive bottle of water can be flavored by a low cost dissolvable flavoring. This provides a custom flavored beverage that is far less expensive than most available pre-made beverages. It also permits the user to flavor the water to suit his or her individual tastes. The dispenser can be conveniently transported to picnics, sporting events, barbecues, etc. so that the flavored beverage may be prepared at virtually any location. The cap of the reusable version is removed after the flavored beverage is consumed and any flavoring residue is emptied from the dispenser. The dispenser can then be cleaned, stored and re-used as required. The disposable dispenser is discarded with the water bottle after the beverage is consumed.

Typically, the cylindrical body of the dispenser should be no greater than one inch in diameter. This allows the dispenser to fit conveniently into the threaded opening of the standard plastic water bottle.

While this detailed description sets forth particularly preferred embodiments of the apparatus of this invention, numerous modifications and variations of the structure of this invention, all within the scope of the invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

Other embodiments will occur to those skilled in the art and are within the following claims:

What is claimed is:

1. A beverage flavoring dispenser for use in dispensing a dissolvable flavoring into drinking water contained in a standard water bottle having a threaded opening with a threadably removable cap, said dispenser comprising:
a cylindrical body having a closed lower end and an interior chamber for accommodating the dissolvable flavoring, said body having a series of perforations formed therein in communication with said chamber; and
an upper closure connected to said body; said body and said closure defining an elongate, substantially tubular enclosure that has a diameter that is narrower than the opening of the standard water bottle such that said enclosure is introducible into the interior of the water bottle through the opening of the bottle, whereby flavoring within said chamber dissolves and is dispensed into the water through said perforations to flavor the water.

2. The device of claim 1 in which said upper closure is removably connected to said body.

3. The device of claim 2 in which said closure and said body are threadably interengaged.

4. The device of claim 1 in which said upper closure is permanently and unitarily attached to said body.

5. The device of claim in which said cylindrical body has a diameter of not greater than one inch.

6. The device of claim 1 further including a flexible filament attached to and extending from said closure.

7. The device of claim 6 further including a tag attached to a distal end of said filament, said tag carrying an indicator for indicating the type of flavoring in said chamber.
